(19) United States
(12) Patent Application Publication
(10) Pub. No.: US 2018/0004846 A1
(43) Pub. Date: Jan. 4, 2018

(54) Explicit Behavioral Targeting of Search Users in the Search Context Based on Prior Online Behavior

(71) Applicant: Microsoft Technology Licensing, LLC, Redmond, WA (US)

(72) Inventors: Shaoyu Zhou, Issaquah, WA (US); Sijian Zhang, Bellevue, WA (US); Aswath Mohan, Bellevue, WA (US); Piyush Naik, Bellevue, WA (US); Lauren M. Dunn, Seattle, WA (US)

(21) Appl. No.: 15/198,443

(22) Filed: Jun. 30, 2016

(51) Int. Cl. G06F 17/30; G06F 3/0481; H04L 29/08

(52) U.S. Cl. CPC G06F 17/30867; H04L 67/02; G06F 3/0481; G06F 17/3053

(57) ABSTRACT

A method of displaying secondary content is disclosed. The method receives historical behavior data and a search query for a user. The method extracts behavior features from the user's historical behavior and scores the user based on the behavioral features to create a user score specific to secondary content. The method uses the user score to display user specific secondary content to the user.

### BACKGROUND

Computer users are able to access diverse content from a variety of content providers over the Internet. Content is stored in servers that are connected by a network. Users can access such content by connecting to the servers through a network connection. Users can also perform search queries to find specific content. The results from search queries are typically displayed as a list of results ranked based on certain criteria such as relevance, dates, or prices. Ranking of the search results improves the user experience by displaying the relevant content for fast and easy user access.

In addition to the ranked results, secondary content is also displayed on the user's screen after a search query. Typically, secondary content providers rely on the user's search queries to display relevant secondary content. Such user targeting improves the overall user experience by catering to the user's interests. But different users have different preferences even within a specific category. Search queries not only typically provide a broad range of results but also allow for display any such secondary content. However, such items are based solely on the user's search queries, and thus do not fully reflect the user's preferences.

### SUMMARY

Non-limiting examples of the present disclosure describe a method of displaying secondary content. The method receives historical behavior data and a search query for a user; extracts behavior features from the user's historical behavior; scores the user based on the behavioral features to create a user scores specific to various types of secondary content; and uses the user scores and the search query to select and display user specific secondary content to the user.

Further non-limiting examples of the present disclosure describe a system for displaying secondary content. The system includes: at least one processor; and a memory operatively connected with the at least one processor storing computer-executable instructions that, when executed by the at least one processor, causes the at least one processor to execute a method. The method receives historical behavior data and a search query for a user; extracts behavior features from the user's historical behavior; scores the user based on the behavioral features to create a user scores specific to various types of secondary content; and uses the user scores and the search query to select and display user specific secondary content to the user.

Further non-limiting examples of the present disclosure describe a non-transitory machine readable storage medium having stored thereon a computer program. The computer program comprises a routine of set instructions for causing the machine to perform the operations of: receiving historical behavior data and a search query for a user; extracting behavior features from the user's historical behavior; scoring the user based on the behavioral features to create a user scores specific to various types of secondary content; and using the user scores and the search query to select and display user specific secondary content to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates a system that allows a user to connect to a content server through a network and retrieve information according to aspects of the present disclosure.

FIG. 2 is a detailed depiction of an example communication system between multiple users, multiple content providers, and the content server through a network at which aspects of the present disclosure may be directed.

FIG. 3 depicts an aspect of the Secondary Content Behavioral Targeting Engine results in the form of a results screen at which aspects of the present disclosure may be directed.

FIG. 4 shows a high level flowchart of the Secondary Content Behavioral Targeting Engine that uses the user data for behavioral targeting during a search query at which aspects of the present disclosure may be directed.

FIG. 5 illustrates a flow chart of the Conversion Prediction Engine at which aspects of the present disclosure may be directed.

FIG. 6 illustrates a flow chart of the Secondary Content Behavioral Targeting Engine that performs daily user scoring and classification of users at which aspects of the present disclosure may be directed.

FIG. 7 is a block diagram illustrating physical components (e.g., hardware) of a computing device with which aspects of the disclosure may be practiced.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

A Secondary Content Behavioral Targeting Engine targets users with specific secondary content. In addition to the user's search queries, the engine also considers the user's historical behavior when selecting the secondary content to be displayed. The engine receives historical behavior data for a user. Different behavior signals are then extracted from the user's historical behavior data. A Conversion Prediction Engine then ranks the behavior signals that best predict the user's future behavior. Content providers can define “conversion” in distinct ways. Many define conversion as a material action taken by the user after just landing on their website. Secondary content providers are interested in increasing their revenue by only targeting users that have a high probability of conversion. The Conversion Prediction Engine then scores the user based on his or her likelihood of conversion. Based on this score, the content that has a higher probability of conversion from the targeted user is selected to be displayed on that user's screen.

Through use of the Secondary Content Behavioral Targeting Engine, searching is made more efficient. Secondary content provided to the targeted user is more likely to be of value to the targeted user because it results from a combination of the user's past behavior on the Internet, as well as his input search query. Thus, a user is more likely to have a positive experience during the web search, and, more importantly, the user is more likely to click through the secondary content to the provider of the secondary content. For example, if a user has previously been on web sites related to sports, and then conducts a search for “shoes,” the secondary content provided to the user may be for web sites related to sports shoes, rather than secondary content that might be of lesser interest to the user, such as high fashion footware. Thus, the secondary content is particularly tailored for this targeted user, and the user is more likely to find the secondary content to be helpful and would be more likely to click through this secondary content. This improves the experience for the user, makes the user's search more efficient, and makes the secondary content provider more likely to receive click throughs.

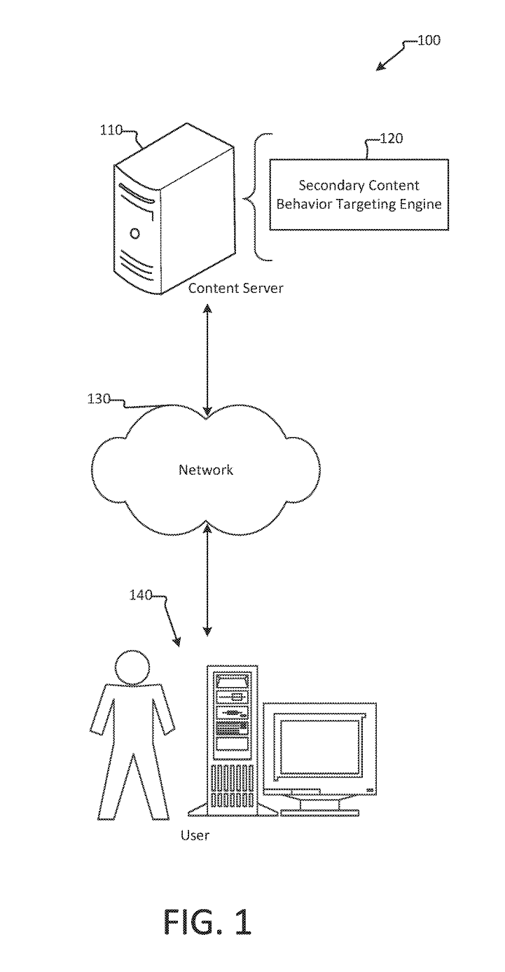

FIG. 1 illustrates an aspect of a system 100 that allows a user 140 to connect to a content server 110 through a network 130 and retrieve information according to aspects of the present disclosure. A content server 110 is a device that hosts information or programs and provides users with management, services, or access to such information or programs. A user 140 can include anyone with access to a computing device that is connected to the content server 110 through a network 130. A computer network includes any connections between computing devices for the purpose of sharing resources such as local area networks, wide area networks, and the Internet. In this case, the content server hosts a Secondary Content Behavioral Targeting Engine 120 that allows for targeted secondary content to be displayed on user device screens based on behavioral signals of the specific users.

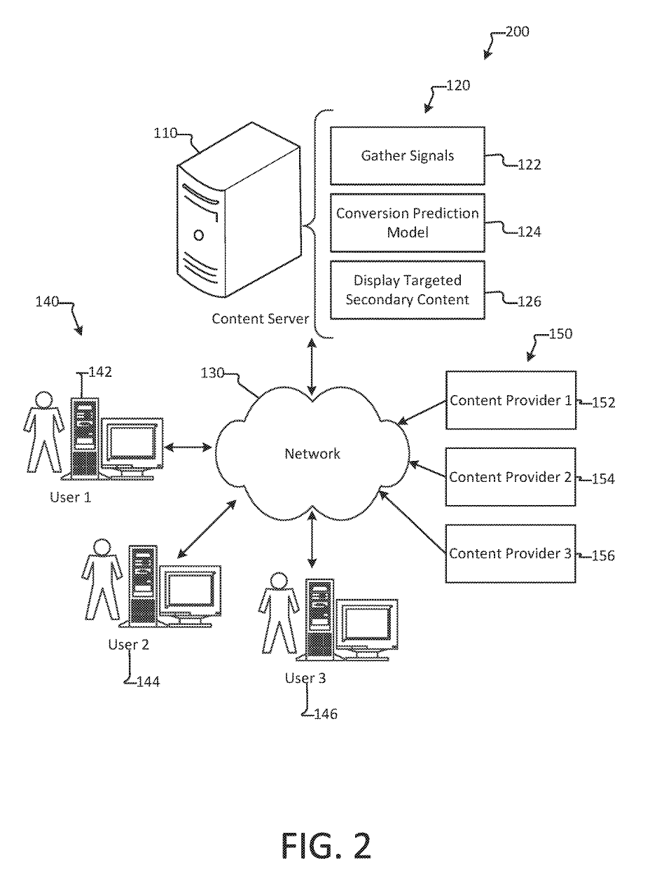

FIG. 2 is a detailed depiction of an example communication system 200 between multiple users 140, multiple content providers 150, and the content server 110 through a network 130 at which aspects of the present disclosure may be directed. One aspect of this communication entails users 140 connecting to the content server 110 when performing a search query. A user's 142 initial query is sent to the content server 110. The content server executes the Secondary Content Behavioral Targeting Engine 120 to deliver the results from the search query as a ranked list to the user 142 along with secondary content provided by content providers 150.

The Secondary Content Behavioral Targeting Engine 120 utilizes a method to customize and deliver the secondary content from the content provider to specific users. First, the Engine 120 may gather signals 122 from the user 142. Signals may include both the search query information as well as the user's historical behavior. These signals may be, for example, the user's historical information from content stored regarding the user's past browsing history. These historical information signals may be extracted from, for example, HTTP cookies stored in the user's web browser, past search queries, clicks, and web and app browsing history. The Engine 120 runs a Conversion Prediction Engine 124 to use the gathered signals to predict the user's likelihood to convert. The same search query from multiple users, 142, 144, and 146 may yield different secondary content provided by different content providers 152, 154, and 156, based on the results of the historical behavior analysis done by the Conversion Prediction Engine 124. The Engine may use its prediction to gather the secondary content that best fits the user's interests and displays the Targeted Secondary Content 126 on the user's screen.

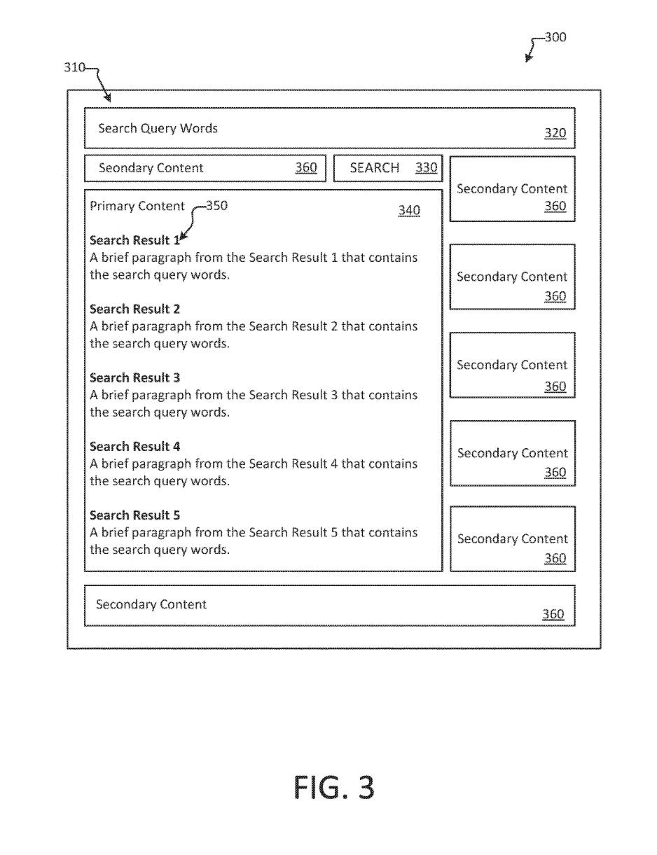

FIG. 3 depicts an aspect of the Secondary Content Behavioral Targeting Engine results in the form of a results screen at which aspects of the present disclosure may be directed. When a user executes a search query, the subsequent search results may be the primary content 340 of the screen and may be displayed on the user's screen as ranked results 350. The ranking of the results may be based on relevance, dates, prices, or any other categories available through the search engine. In addition, the Secondary Content Behavioral Targeting Engine displays secondary content 360 on the screen that is based on the search query as well as the user's historical behavior.

The Secondary Content Behavioral Targeting Engine's consideration of the user's historical behavior, in addition to the user's search queries, when selecting the secondary content to be displayed, allows for the selected secondary content to be targeted to the interests of the user. This increases the user's probability of conversion. Users want the displayed secondary content to reflect their interests. An engine that displays targeted secondary content that reflects the user's preferences serves both parties' interests.

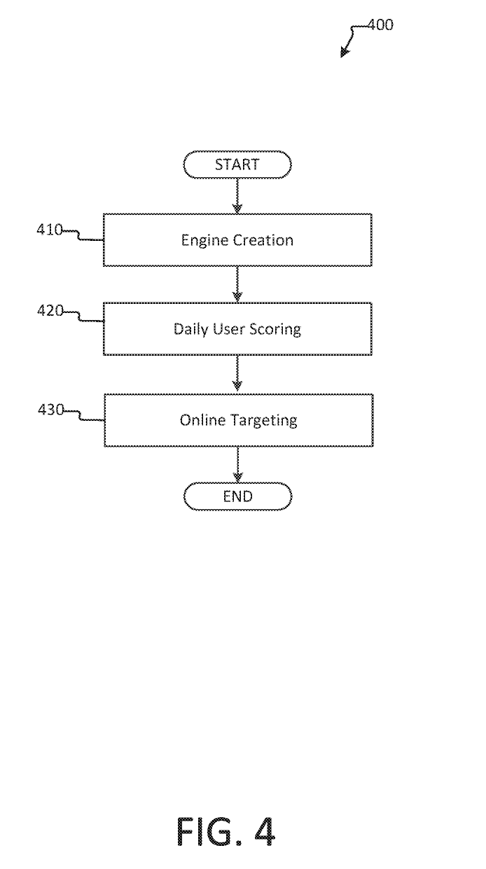

FIG. 4 shows a high level flowchart of the Secondary Content Behavioral Targeting Engine that uses the user data for behavioral targeting during a search query at which aspects of the present disclosure may be directed. During engine creation the Conversion Prediction Engine is initially created and tested (stage 410). After the creation and testing of the engine, the users may be scored and classified into buckets based on the probability of conversion (stage 420). The users are targeted by content providers based on their classification from the previous stage (stage 430).

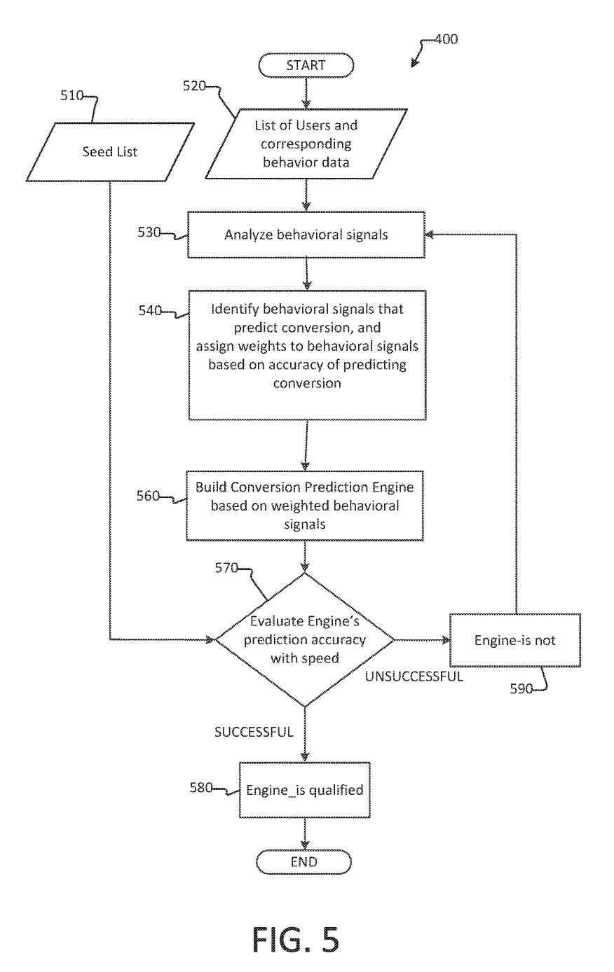

FIG. 5 illustrates a flow chart of the Conversion Prediction Engine 410 at which aspects of the present disclosure may be directed. A seed list of users and their historical behavior and conversion data may be initially obtained from the content provider (stage 510). The seed list may contain positive and negative seeded users. The Secondary Content Behavioral Targeting Engine may collect behavioral data from the set of users (stage 520). The behavioral signals may be analyzed by the engine (stage 530). The relevant behavioral signals that may predict conversion events of a user may be identified by the engine. These signals may include, but are not limited to, clicks of the user, user search queries, and user page views. The engine may use this historical data to assign weights to different behavioral signals based on the accuracy of the feature in predicting conversion behavior (stage 540). Behavioral signals that have a higher probability of predicting conversion from a user may be given a higher score than behavioral signals that are less likely to predict a conversion event. At this point the engine is ready to be used to predict future conversion events of users (stage 560). The engine is then evaluated based on the Seed list of users and the historical data that is already available (stage 570). If the engine is successful in predicting user conversions, the engine is said to be qualified and is ready to be used (stage 580). If not, the behavioral signals that were used in building the engines are re-analyzed and the engine is tweaked (stage 590).

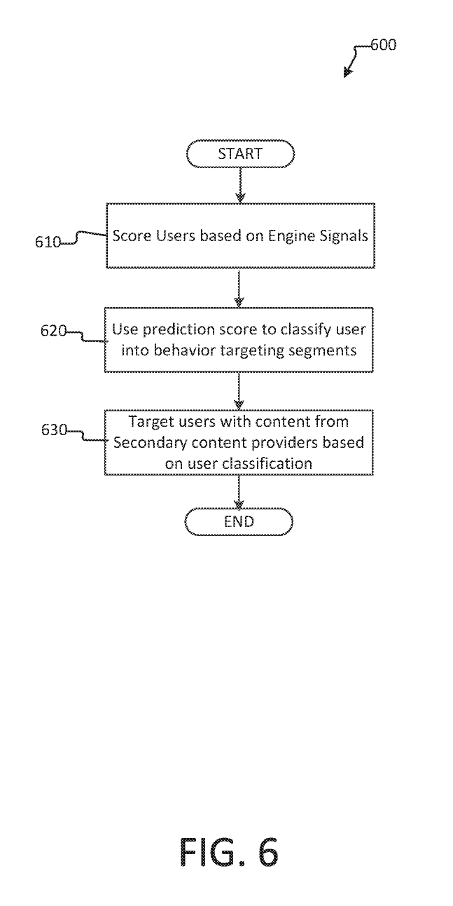

FIG. 6 illustrates a flow chart of the Secondary Content Behavioral Targeting Engine 420 that performs daily user scoring and classification of users at which aspects of the present disclosure may be directed. After the Conversion Prediction Engine is created and qualified, it is ready to be used to predict user conversion. Each user may be given a score based on weighted behavioral signals (stage 610). This score predicts the probability that the user converts on content related to the particular secondary content provider's site. This score is then used to classify the user into behavioral targeting segments (stage 620). Secondary content providers can then target the users based on if they fall within the classification that coincides with their content (stage 630).

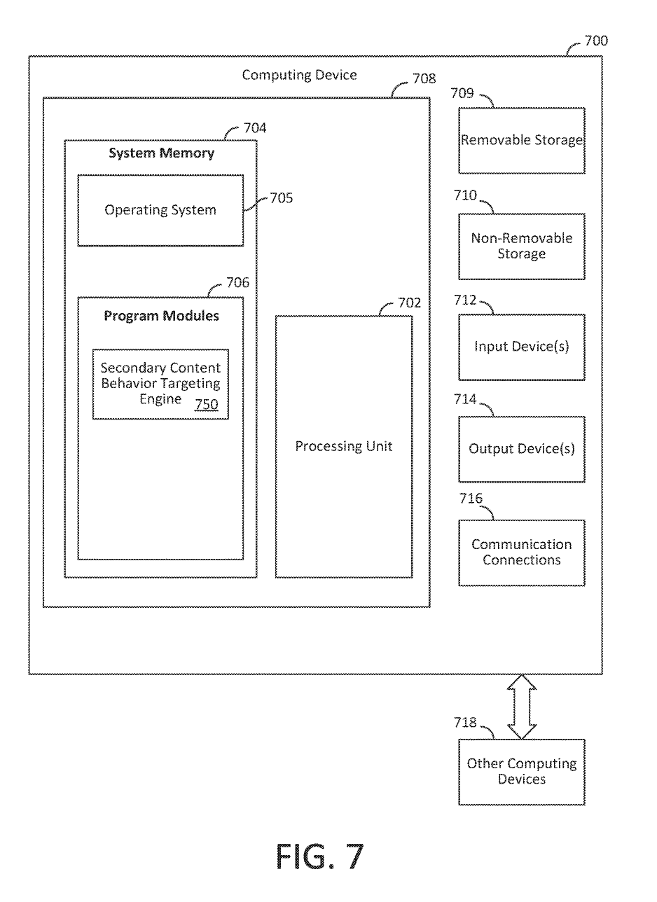

FIG. 7 is a block diagram illustrating physical components (e.g., hardware) of a computing device 700 with which aspects of the disclosure may be practiced. The computing device components described below may have computer executable instructions for implementing a secondary content behavioral targeting engine application 650 on a computing device, including computer executable instructions that can be executed to implement the methods disclosed herein. In a basic configuration, the computing device 700 may include at least one processing unit 702 and a system memory 704. The computing device 700 may be, for example, a server, a desktop computer, a portable computer, or a mobile computing device. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running secondary content behavioral targeting engine application 750.

The operating system 705, for example, may be suitable for controlling the operation of the computing device 700. Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., secondary content behavioral targeting engine application 750) may perform processes including, but not limited to, the aspects, as described herein. Other program modules that may be used in accordance with aspects of the present disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method, comprising:
receiving historical behavior data and a search query for a user;
extracting behavior features from the user's historical behavior;
scoring the user based on the behavioral features to create a user scores specific to various types of secondary content; and
using the user scores and the search query to select and display user specific secondary content to the user.

2. The method of claim 1, further comprising generating a conversion prediction engine based on historical behavior data from a plurality of users.

3. The method of claim 2, wherein generating a conversion prediction engine comprises:
receiving historical behavior data from a plurality of users;
identifying relevant behavioral signals that may predict conversion events of the users from the historical behavior data; and
weighting the relevant behavioral signals based on their accuracy in prediction conversion by the users to generate the conversion prediction engine.

4. The method of claim 3, further comprising evaluating the conversion prediction engine.

5. The method of claim 4, wherein scoring the user comprises scoring the user using the conversion prediction engine.

6. The method of claim 1, wherein scoring the user based on the behavioral features to create a user score based on various types of secondary content further comprises scoring the user based on both the behavioral features and the search query.

7. The method of claim 1, wherein historical behavior data includes past browsing history, previous search behavior, and click behavior.

8. The method of claim 1, wherein historical behavior data includes data stored in HTTP cookies.

9. A system, comprising:
at least one processor; and
memory, operatively connected to the at least one processor and storing instructions that, when executed by the at least processor, cause the at least one processor to perform a method for generating the display of specific secondary content, the method comprising:
receiving historical behavior data and a search query for a user;
extracting behavior features from the user's historical behavior;
scoring the user based on the behavioral features to create a user scores specific to various types of secondary content; and
using the user scores and the search query to select and display user specific secondary content to the user.

10. The system of claim 9, wherein the method, executed by the at least one processor, further comprises, generating a conversion prediction engine based on historical behavior data from a plurality of users.

11. The system of claim 10, wherein generating a conversion prediction engine comprises:
receiving historical behavior data from a plurality of users;
identifying relevant behavioral signals that may predict conversion events of the users from the historical behavior data; and
weighting the relevant behavioral signals based on their accuracy in prediction conversion by the users to generate the conversion prediction engine.

12. The system of claim 11, wherein the method, executed by the at least one processor, further comprises, evaluating the conversion prediction engine.

13. The system of claim 12, wherein scoring the user comprises scoring the user using the conversion prediction engine.

14. The system of claim 9, wherein scoring the user based on the behavioral features to create a user score based on various types of secondary content further comprises scoring the user based on both the behavioral features and the search query.

15. The system of claim 9, wherein historical behavior data includes past browsing history, previous search queries, and click behavior.

16. The system of claim 9, wherein historical behavior data includes data stored in HTTP cookies.

17. A non-transitory machine readable storage medium having stored thereon a computer program, the computer program comprising a routine of set instructions for causing the machine to perform the operations of:
receiving historical behavior data and a search query for a user;
extracting behavior features from the user's historical behavior;
scoring the user based on the behavioral features to create a user scores specific to various types of secondary content; and
using the user scores and the search query to select and display user specific secondary content to the user.

18. The non-transitory machine readable storage medium of claim 17, wherein the computer program comprises additional instructions to perform the operation of generating a conversion prediction engine based on historical behavior data from a plurality of users.

19. The non-transitory machine readable storage medium of claim 18, wherein generating a conversion prediction engine comprises:
receiving historical behavior data from a plurality of users;
identifying relevant behavioral signals that may predict conversion events of the users from the historical behavior data; and
weighting the relevant behavioral signals based on their accuracy in prediction conversion by the users to generate the conversion prediction engine.

20. The non-transitory machine readable storage medium of claim 19, wherein the computer program comprises additional instructions to perform the operation of evaluating the conversion prediction engine.
